(19) United States
(12) Patent Application Publication
(10) Pub. No.: US 2024/0418942 A1
(43) Pub. Date: Dec. 19, 2024

(54) DISPLAY STRUCTURE AND DISPLAY DEVICE

(71) Applicant: DISPELIX OY, Espoo (FI)

(72) Inventors: Timo HASSINEN, Espoo (FI); Juuso OLKKONEN, Espoo (FI)

(73) Assignee: DISPELIX OY, Espoo (FI)

(21) Appl. No.: 18/687,740

(22) PCT Filed: Aug. 24, 2022
(86) PCT No.: PCT/FI2022/050548

§ 371 Date: Feb. 28, 2024

(30) Foreign Application Priority Data
Sep. 3, 2021 (FI) 20215929

(51) Int. Cl. G02B 6/34; G02B 27/01

(52) U.S. Cl. CPC G02B 6/34; G02B 27/0172

(57) ABSTRACT

A display structure and a display device are disclosed. The display structure includes a waveguide having a first face and a second face and an out-coupling grating arranged on the first face and configured to couple light out via the second face. The out-coupling grating includes a primary ridge having a first end facing a secondary lateral direction, a first ridge portion extending towards a primary lateral direction opposite to the secondary lateral direction from the first end, a second end facing the primary lateral direction, and a second ridge portion extending towards the secondary lateral direction from the second end. The first ridge portion has a first height, h₁, and the second ridge portion has a second height, h₂, less than the first height, h₁.

### FIELD OF TECHNOLOGY

This disclosure concerns display devices. In particular, this disclosure concerns waveguide-based display devices with diffractive out-coupling gratings, and structures therefor.

### BACKGROUND

An out-coupling grating of a waveguide-based display device typically couples light out of a waveguide both towards and away from the user's eyes. In many applications, for example, in head-mounted see-through display devices (e.g., smart glasses), coupling of light away from the user's eye(s), i.e., towards the world side, may be undesirable for a variety of reasons, including energy efficiency, information security, and aesthetics.

Conventionally, out-coupling of light by different out-coupling gratings towards the world side is reduced by usage of various thin film stacks arranged underneath or over the out-coupling gratings. Although such approach can provide display devices with acceptable out-coupling efficiency characteristics, optical leakage exhibited by conventional solutions may be excessive, especially in case of TM-polarized input light.

In light of the above, it may be desirable to develop new solutions related to out-coupling gratings of waveguide-based display devices.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to a first aspect, display structure is provided. The display structure comprises a waveguide comprising a first face and a second face for confining light in the waveguide by total internal reflection. The second face is arranged towards a thickness direction from the first face. The display structure further comprises a diffractive out-coupling grating arranged on the first face. The out-coupling grating is configured to couple light out of the waveguide via the second face. The out-coupling grating comprises a primary ridge and a secondary ridge parallel to the primary ridge. The secondary ridge is arranged towards a primary lateral direction from the primary ridge. The primary ridge comprises a first end facing a secondary lateral direction opposite to the primary lateral direction, a first ridge portion extending towards the primary lateral direction from the first end, a second end facing the primary lateral direction, and a second ridge portion extending towards the secondary lateral direction from the second end. The first ridge portion has a first height, measured along the thickness direction, and the second ridge portion has a second height, measured along the thickness direction, less than the first height.

According to a second aspect, a display device comprising a display structure according to the first aspect is provided.

### BRIEF DESCRIPTION OF THE DRAWINGS

The present disclosure will be better understood from the following detailed description read in light of the accompanying drawings, wherein:

FIG. 1 shows a cross-sectional view of a display structure,

FIG. 2 depicts a cross-sectional view of another display structure, and

FIG. 3 illustrates display device.

Unless specifically stated to the contrary, any drawing of the aforementioned drawings may be not drawn to scale such that any element in said drawing may be drawn with inaccurate proportions with respect to other elements in said drawing in order to emphasize certain structural aspects of the embodiment of said drawing.

Moreover, corresponding elements in the embodiments of any two drawings of the aforementioned drawings may be disproportionate to each other in said two drawings in order to emphasize certain structural aspects of the embodiments of said two drawings.

### DETAILED DESCRIPTION

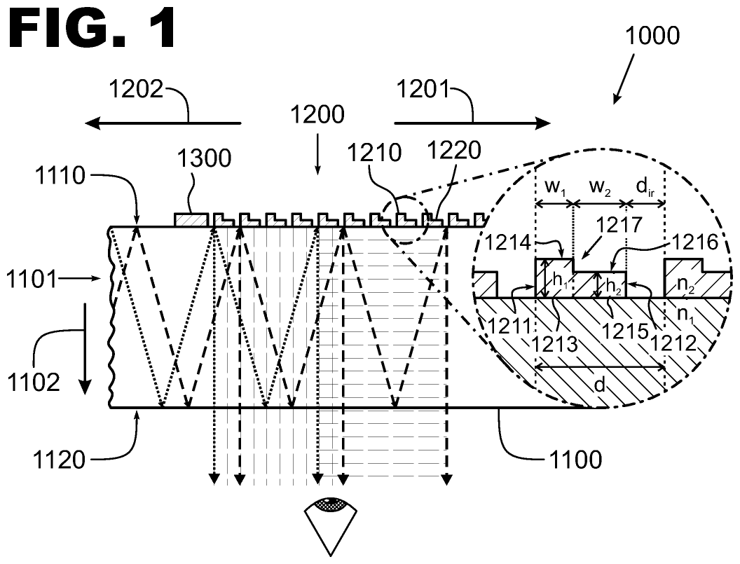

FIG. 1 depicts a partial cross-sectional view of a display structure 1000 according to an embodiment and a magnified view of a part of the display structure 1000.

In this specification, a “display device” may refer to an operable output device, e.g., electronic device, for visual presentation of images and/or data. A display device may generally comprise any part(s) or element(s) necessary or beneficial for visual presentation of images and/or data, for example, a power unit; an optical engine; a combiner optics unit, such as a waveguide-based combiner optics unit; an eye tracking unit; a head tracking unit; a gesture sensing unit; and/or a depth mapping unit. A display device may or may not be a portable display device, for example, a head-mounted display device, and/or a see-through display device.

Herein, a “head-mounted display device” may refer to a display device configured to be worn on the head, as part of a piece of headgear, and/or on or over the eyes.

Further, a “see-through display device” or “transparent display device” may refer to a display device allowing its user to see the images and/or data shown on the display device as well as to see through the display device.

Throughout this disclosure, a “display structure” may refer to at least part of an operable display device. Additionally of alternatively, a display structure may refer to a structure suitable for use in a display device.

In the embodiment of FIG. 1, the display structure 1000 comprises a waveguide 1100.

In this disclosure, a “waveguide” may refer to an optical waveguide. Additionally or alternatively, a waveguide may refer to a two-dimensional waveguide, wherein light may be confined along a thickness direction of said waveguide.

The waveguide 1100 of the embodiment of FIG. 1 comprises a first face 1110 and a second face 1120 for confining light 1101 in the waveguide 1100 by total internal reflection. The second face is arranged opposite the first face 1110 and towards a thickness direction 1102 therefrom.

In this disclosure, a “face” of a waveguide may refer 10 to a part of a surface of said waveguide viewable from or facing a certain viewing direction. Additionally or alternatively, faces of a waveguide may refer to surfaces suitable for or configured to confine light in said waveguide by total internal reflection.

In the embodiment of FIG. 1, the display structure 1000 also comprises a diffractive out-coupling grating 1200 arranged on the first face 1110.

In this specification, a “diffraction grating”, may refer to an optical grating the operation of which is based on diffraction of visible light. Generally, a diffraction grating may comprise one or more structural features with at least one dimension of the order of the wavelengths of visible light, for example, at least one dimension less than one micrometer. Generally, a diffraction grating may be implemented as a single-region diffraction grating or as a multi-region diffraction grating. Diffraction gratings may generally be implemented, at least, as surface relief diffraction gratings or volume holographic diffraction gratings, and they May be configured to function as transmission- and/or reflection-type diffraction gratings. Naturally, a “diffractive out-coupling grating” may then refer to a diffraction grating configured to couple light out of a waveguide. Generally, a diffractive out-coupling grating may further be configured to perform exit pupil expansion by pupil replication.

Herein, “exit pupil expansion” may refer to a process of distributing light within a waveguide in a controlled manner so as to expand a portion of said waveguide where out-coupling of light occurs. Further, “pupil replication” may refer to an exit pupil expansion process, wherein a plurality of exit sub-pupils are formed in an imaging system.

The out-coupling grating 1200 is configured to couple light 1101 out of the waveguide 1100 via the second face 1120. Consequently, the out-coupling grating 1200 is configured to function as a reflection-type diffraction grating.

The out-coupling grating 1200 of the embodiment of FIG. 1 comprises a primary ridge 1210 and a secondary ridge 1220 parallel to the primary ridge 1210. In FIG. 1, each of the primary ridge 1210 and the secondary ridge 1220 extends longitudinally perpendicular to the plane of the drawing, and the secondary ridge 1220 is arranged towards a primary lateral direction 1201 from the primary ridge 1210.

As depicted in the inset of FIG. 1, the primary ridge 1210 comprises a first end 1211 facing a secondary lateral direction 1202 opposite to the primary lateral direction 1201 and a first ridge portion 1213 extending towards the primary lateral direction 1201 from the first end 1211. The primary ridge 1210 also comprises a second end 1212 facing the primary lateral direction 1201 and a second ridge portion 1215 extending towards the secondary lateral direction 1202 from the second end 1212.

In the embodiment of FIG. 1, the first ridge portion 1213 has a first height (h₁) measured along the thickness direction 1102, and the second ridge portion 1215 has a second height (h₂) measured along the thickness direction 1102, less than h₁. Generally, a first ridge portion having a first height and a second ridge portion having a second height less than the first height may enable increasing the out-coupling efficiency of light towards a user's eye(s) and/or increasing the ratio of the out-coupling efficiency towards the user's eye(s) to the out-coupling efficiency towards the world side. The out-coupling efficiency of light towards a user's eye(s) may be considerable for both TE- and TM-polarized input light. An increase in such out-coupling efficiency compared to conventional solutions may be observed particularly for TM-polarized input light.

Herein, a “height” of a ridge portion may refer to a measure of the extent of said ridge portion along a thickness direction of a waveguide. When an out-coupling grating comprises a primary ridge and a secondary ridge, said out-coupling grating may comprise a gap between said primary ridge and said secondary ridge, and a height of a ridge portion of said primary ridge may be measured from a lowest point of said gap to a highest point of said ridge portion.

In the embodiment of FIG. 1, the out-coupling grating 1200 is specifically configured to couple out light 1101, which is confined in the waveguide 1100 by total internal reflection and is guided towards the primary lateral direction 1201. In other embodiments, an out-coupling grating may or may not be configured to couple light guided towards a primary lateral direction out of a waveguide via a second face thereof. For example, in some embodiments, an out-coupling grating may be configured to couple light guided towards any suitable direction, for example, a direction perpendicular to a thickness direction and forming an acute angle, such as an angle less than or equal to 45°, or to 30°, or to 20°, or to 15°, or to 10°, or to 5°, with a primary lateral direction.

The out-coupling grating 1200 of the embodiment of FIG. 1 is configured to perform exit pupil expansion by pupil replication along the primary lateral direction 1201. In other embodiments, an out-coupling grating may or may not be configured to perform exit pupil expansion by pupil replication along at least a primary lateral direction, i.e., along a primary lateral direction and, optionally, along one or more other directions perpendicular to a thickness direction.

In the embodiment of FIG. 1, a height ratio (rₕ) between h₂ and h₁, may be approximately 0.7. In other embodiments, any suitable height ratio, for example, a height ratio greater than or equal to 0.45, or to 0.5, or to 0.55, or to 0.6 and/or less than or equal to 0.9, or to 0.85, or to 0.8, or to 0.75, may be used.

In the embodiment of FIG. 1, h₁ may be approximately 65 nm. In other embodiments, a first ridge portion may have any suitable first height, for example, a first height greater than or equal to 40 nm, or to 45 nm, or to 50 nm and/or less than or equal to 200 nm, or to 180 nm, or to 160 nm.

In the embodiment of FIG. 1, h₂ may be approximately 45 nm. In other embodiments, a second ridge portion may have any suitable second height, for example, a second height greater than or equal to 20 nm, or to 25, or to 30 nm and/or less than or equal to 150 nm, or to 140 nm, or to 120 nm.

The display structure 1000 of the embodiment of FIG. 1 comprises a coating 1300 on the first face 1110, and the out-coupling grating 1200 is formed in the coating 1300. Generally, an out-coupling grating being formed in a coating may facilitate fabrication of a display structure and/or facilitate tuning the diffraction efficiency of an out-coupling grating without altering the refractive index of a waveguide. In other embodiments, a display structure may or may not comprise a coating on a first face of a waveguide. In embodiments, wherein a display structure comprises a coating on a first face of a waveguide, an out-coupling grating may or may not be formed in said coating. In some embodiments, an out-coupling grating may be at least partly, i.e., partly or entirely, formed into a waveguide.

The waveguide 1100 of the embodiment of FIG. 1 comprises a first material having a first refractive index (n₁) at a visible wavelength (λᵥᵢₛ) and the coating 1300 comprises a second material having a second refractive index (n₂) higher than n₁ at λᵥᵢₛ. Generally, a coating comprising a second material having a second refractive index higher than said first refractive index may enable reducing a first height of a first ridge portion and a second height of a second ridge portion, which may, in turn, facilitate fabrication of a display structure, and/or increasing the ratio of the out-coupling efficiency towards the user's eye(s) to the out-coupling efficiency towards the world side. In other embodiments, wherein a waveguide comprises, consists essentially of, or consists of a first material having a first refractive index at a visible wavelength, a coating may or may not comprise, consist essentially of, or consist of a second material having a second refractive index higher than said first refractive index at said visible wavelength.

In the embodiment of FIG. 1, a refractive index difference (Δn) between n₂ and n₁ at λᵥᵢₛ may be approximately 0.7. Generally, a higher refractive index difference may further increase the out-coupling efficiency of light towards a user's eye(s) and/or increase the ratio of the out-coupling efficiency towards the user's eye(s) to the out-coupling efficiency towards the world side. In other embodiments, any suitable refractive index difference between a second refractive index and a first refractive index may be used. For example, in some embodiments, a refractive index difference greater than or equal to 0.3, or to 0.4, or to 0.5, or to 0.6, or to 0.7 may be used.

In the embodiment of FIG. 1, n₁ may be approximately 2 at λᵥᵢₛ, whereas n₂ may be approximately 2.7 at λᵥᵢₛ. In other embodiments, any suitable refractive indices may be used. For example, in some embodiments, n₁ may be greater than or equal to 1.5 or to 1.6 and/or less than or equal to 2.1 or to 2.0 at λᵥᵢₛ may be used. In such embodiments, n₂ may be, for example, greater than or equal to 2.2, or to 2.3 and/or less than or equal to 3, or to 2.8.

In case of the embodiment of FIG. 1, the values of n₁, n₂, and Δn may be considered at a λᵥᵢₛ of 500 nm. In other embodiments, the values of n₁, n₂, and Δn may be considered at any suitable visible wavelength, i.e., any wavelength within a spectral range extending from 380 nm to 760 nm. For example, in some embodiments, the relevant visible wavelength may be selected from the group consisting of 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, and 650 nm.

The first material of the waveguide 1100 of the embodiment of FIG. 1 may be, for example, high-refractive-index glass, and the second material of the coating 1300 may be, for example, titanium dioxide (TiO₂). In other embodiments, any suitable material(s), for example, inorganic material(s), such as glass(es), oxide material(s) and/or nitride material(s); or organic polymer(s), may be used as first material and/or as second material.

In the embodiment of FIG. 1, the out-coupling grating 1200 has a period (d) and an inter-ridge distance (dᵢᵣ) measured along the primary lateral direction 1201 between the primary ridge 1210 and the secondary ridge 1220. The out-coupling grating 1200 may have a distance ratio (r_{d}) between dᵢᵣ and d of approximately 0.1. Generally, a lower distance ratio may increase the out-coupling efficiency of light towards a user's eye(s) and/or increase the ratio of the out-coupling efficiency towards the user's eye(s) to the out-coupling efficiency towards the world side. In other embodiments, any suitable distance ratio, for example, a distance ratio less than or equal to 0.25, or to 0.2, or to 0.15, or to 0.1, may be used.

In case of the embodiment of FIG. 1, d may be approximately 340 nm. In other embodiments, any suitable period, for example, a period greater than or equal to 300 nm, or 310 nm, or to 320 nm, or to 325 nm and/or less than or equal to 470 nm, or to 460 nm, or to 450 nm, or to 440 nm may be used.

In case of the embodiment of FIG. 1, dᵢᵣ may be approximately 30 nm. In other embodiments, any suitable inter-ridge distance, for example, an inter-ridge distance greater than or equal to 15 nm, or to 20 nm, or to 25 nm, or to 30 nm and/or less than or equal to 100 nm, or to 80 nm, or to 60 nm, or to 50 nm may be used.

The first ridge portion 1213 of the embodiment of FIG. 1 is adjacent to the second ridge portion 1215, and the primary ridge 1210 comprises a step structure 1217 arranged between the first ridge portion 1213 and the second ridge portion 1215. Consequently, the out-coupling grating 1200 of the embodiment of FIG. 1 is implemented as a three-level, i.e., two-step, stepped diffraction grating. Generally, utilization of stepped diffraction gratings, such as three-level stepped diffraction gratings, in a display structure may facilitate fabrication of said display structure. In other embodiments, a first ridge portion of a primary ridge may or may not be adjacent to a second ridge portion of said primary ridge, and said primary ridge may or may not comprise a step structure arranged between said first ridge portion and said second ridge portion.

In the embodiment of FIG. 1, the first ridge portion 1213 comprises a lateral first outer surface 1214 extending from the first end 1211, and the second ridge portion 1215 comprises a lateral second outer surface 1216 extending from the second end wall. In other embodiments, a first ridge portion may or may not comprise such lateral first outer surface and/or a second ridge portion may or may not comprise such lateral second outer surface.

In the embodiment of FIG. 1, the first ridge portion 1213 has a first width (w₁), measured along the primary lateral direction 1201, and the second ridge portion 1215 has a second width (w₂), measured along the primary lateral direction 1201, greater than w₁. In other embodiments, wherein a first ridge portion is adjacent to a second ridge portion, a second width of a second ridge portion may or may not be greater than a first width of a first ridge portion. In some embodiments, a second ridge portion may have a second width less than or equal to a first width of a first ridge portion.

In the embodiments of FIG. 1, a width ratio (r_{w}) between w₂ and w₁ may be approximately 1.4. In other embodiments, wherein a first ridge portion is adjacent to a second ridge portion, any suitable width ratio may be used. In other embodiments, wherein a second width of a second ridge portion is greater than a first width of a first ridge portion a width ratio greater than or equal to 1.1, or to 1.2, or to 1.3, or to 1.4 and/or less than or equal to 3, or to 2.8, or to 2.6, or to 2.5, or to 2.4 may be used, for example.

In case of the embodiment of FIG. 1, w₁ may be approximately 130 nm. In other embodiments, wherein a first ridge portion is adjacent to a second ridge portion, a first ridge portion may have any suitable first width, for example, a first width greater than or equal to 80 nm, or to 100 nm, or to 120 nm and/or less than or equal to 300 nm, or to 280 nm, or to 260 nm.

In the embodiment of FIG. 1, w₂ may be approximately 180 nm. In other embodiments, wherein a first ridge portion is adjacent to a second ridge portion, a second ridge portion may have any suitable second width, for example, a second width greater than or equal to 100 nm, or to 120 nm, or to 140 nm and/or less than or equal to 300 nm, or to 280 nm, or to 260 nm.

In the embodiment of FIG. 1, the out-coupling grating 1200 is configured to minimize coupling of light 1101 out of the waveguide 1100 via the first face 1110. In particular, each of rₕ, h₁, h₂, r_{w}, w₁, w₂, r_{d}, d, and dᵢᵣ is selected to minimize coupling of light 1101 out of the waveguide 1100 towards the world side. In other embodiments, an out-coupling grating may or may not be configured to minimize coupling of light out of a waveguide via a first face. In embodiments, wherein an out-coupling grating is configured to minimize coupling of light out of a waveguide via a first face, one or more of a height ratio, a first height, a second height, a width ratio, a first width, a second width, a distance ratio, a period, and an inter-ridge distance may be selected to minimize coupling of light out of said waveguide via said first face.

The display structure 1000 of the embodiment of FIG. 1 may have been formed at least partly using nanoimprint lithography. In other embodiments, any suitable fabrication method(s), for example, nanoimprint lithography and/or grayscale electron-beam lithography, may be used.

In the embodiment of FIG. 1, the out-coupling grating 1200 comprises a plurality of ridges with cross-sectional shapes identical to those of the primary ridge 1210. In particular, the secondary ridge 1220 has a shape identical to that of the primary ridge 1210. In other embodiments, an out-coupling grating may or may not comprise a plurality, i.e., two or more, three or more, four or more, etc., of ridges with cross-sectional shapes identical to those of a primary ridge of said out-coupling grating. In embodiments, wherein an out-coupling grating comprises a plurality of ridges with cross-sectional shapes identical to those of a primary ridge of said out-coupling grating, a secondary ridge may or may not have a shape identical to that of said primary ridge.

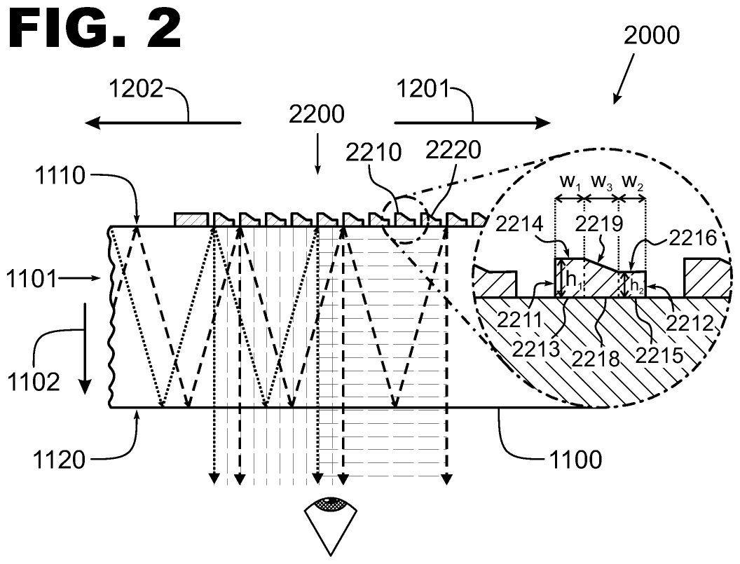

FIG. 2 depicts a display structure 2000 according to an embodiment. The embodiment of FIG. 2 may be in accordance with any of the embodiments disclosed with reference to and/or in conjunction with FIG. 1. Additionally or alternatively, although not explicitly shown in FIG. 2, the embodiment of FIG. 2 or any part thereof may generally comprise any features and/or elements of the embodiment of FIG. 1 which are omitted from FIG. 2.

Similarly to the display structure 1000 of the embodiment of FIG. 1, the display structure 2000 of the embodiment of FIG. 2 comprises a diffractive out-coupling grating 2200 arranged on a first face 1110 of a waveguide 1100 and configured to couple light 1101 out of the waveguide 1100 via a second face 1120 thereof. However, the cross-sectional shapes of the primary ridge 2210 and the secondary ridge 2220 of the out-coupling grating 2200 differ from those of the primary ridge 1210 and the secondary ridge 1220 of the out-coupling grating 1200 of the embodiment of FIG. 1.

In a manner similar to the primary ridge 1210 of the embodiment of FIG. 1, the primary ridge 2210 of the embodiment of FIG. 2 comprises a first end 2211 facing a secondary lateral direction 1202 opposite to a primary lateral direction 1201, a first ridge portion 2213 extending towards the primary lateral direction 1201 from the first end 2211, a second end 2212 facing the primary lateral direction 1201, and a second ridge portion 2215 extending towards the secondary lateral direction 1202 from the second end 2212. The first ridge portion 2213 has a first height (h₁), measured along a thickness direction 1102. The second ridge portion 2215 has a second height (h₂), measured along the thickness direction 1102, less than h₁.

Contrary to the embodiment of FIG. 1, the first ridge portion 2213 comprises a lateral first outer surface 2214 extending from the first end 2211, the second ridge portion 2215 comprises a lateral second outer surface 2216 extending from the second end 2212, and the primary ridge 2210 comprises an intermediate ridge portion 2218 extending from the first ridge portion 2213 to the second ridge portion 2215 and comprising a sloping intermediate outer surface 2219 connecting the first outer surface 2214 and the second outer surface 2216. Generally, such intermediate ridge portion may further increase the out-coupling efficiency of light towards a user's eye(s) and/or increase the ratio of the out-coupling efficiency towards the user's eye(s) to the out-coupling efficiency towards the world side.

In the embodiment of FIG. 2, In between h₂ and h₁, may be approximately 0.6. For example, h₁ may be approximately 90 nm, whereas h₂ may be approximately 55 nm.

The out-coupling grating 2200 of the embodiment of FIG. 2 may have a r_{d} between dᵢᵣ and d of approximately 0.1. For example, d may be approximately 370 nm, and dᵢᵣ may be approximately 40 nm.

In the embodiment of FIG. 2, a r_{w} between w₂ and w₁ may be approximately 0.9. In other embodiments, wherein a primary ridge comprises an intermediate ridge portion comprising a sloping intermediate outer surface, any suitable width ratio, for example, a width ratio greater than or equal to 0.8, or to 0.9, or to 1.0, or to 1.1 and/or less than or equal to 2, or to 1.8, or to 1.6, or to 1.4 may be used.

In case of the embodiment of FIG. 2, w₁ may be approximately 110 nm. In other embodiments, wherein a primary ridge comprises an intermediate ridge portion comprising a sloping intermediate outer surface, a first ridge portion may have any suitable first width, for example, a first width greater than or equal to 60 nm, or to 80 nm, or to 100 nm and/or less than or equal to 300 nm, or to 280 nm, or to 260 nm.

In the embodiment of FIG. 2, w₂ may be approximately 100 nm. In other embodiments, wherein a primary ridge comprises an intermediate ridge portion comprising a sloping intermediate outer surface, a second ridge portion may have any suitable second width, for example, a second width greater than or equal to 60 nm, or to 80 nm, or to 100 nm and/or less than or equal to 300 nm, or to 280 nm, or to 260 nm.

In the embodiment of FIG. 2, the intermediate ridge portion 2218 has a third width (w₃), measured along the primary lateral direction 1201, greater than either of w₁ and w₂. In other embodiments, wherein a primary ridge comprises an intermediate ridge portion comprising a sloping intermediate outer surface, said intermediate ridge portion may or may not have a third width greater than w₁ and/or w₂. In some embodiments, an intermediate ridge portion may have a third width less than or equal to w₁ and/or w₂.

In the embodiment of FIG. 2, w₃ may be approximately 120 nm. In other embodiments, wherein a primary ridge comprises an intermediate ridge portion comprising a sloping intermediate outer surface, an intermediate ridge portion may have any suitable third width, for example, a third width greater than or equal to 60 nm, or to 80 nm, or to 100 nm and/or less than or equal to 300 nm, or to 280 nm, or to 260 nm.

Above, mainly structural and material-related features of display structures are discussed. In the following, more emphasis will lie on features related to display devices. What is said above about the ways of implementation, definitions, details, and advantages applies, mutatis mutandis, to the display device aspect discussed below. The same applies vice versa.

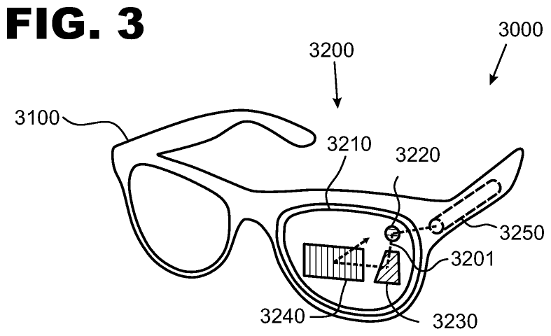

FIG. 3 depicts a display device 3000 according to an embodiment. The embodiment of FIG. 3 may be in accordance with any of the embodiments disclosed with reference to and/or in conjunction with any of FIGS. 1 and 2. Additionally or alternatively, although not explicitly shown in FIG. 3, the embodiment of FIG. 3 or any part thereof may generally comprise any features and/or elements of any of the embodiments of FIGS. 1 and 2 which are omitted from FIG. 3.

In the embodiment of FIG. 3, the display device 3000 is implemented as a see-through head-mounted display device, more specifically, as spectacles comprising a see-through display. In other embodiments, a display device may be implemented in any suitable manner, for example, as a see-through and/or as a head-mounted display device.

In the embodiment of FIG. 3, the display device 3000 comprises a frame 3100 and a display structure 3200 according to the first aspect supported by the frame 3100.

In other embodiments, a display device may or may not comprise such frame.

In the embodiment of FIG. 3, the display structure 3200 comprises a waveguide 3210, an in-coupling grating 3220 for coupling light 3201 into the waveguide 3210, an intermediate pupil expansion structure 3230 configured to receive light 3201 from the in-coupling grating 3220, and a reflection-type out-coupling grating 3240 configured to receive light 3201 from the intermediate pupil expansion structure 3230. In other embodiments, a display structure may or may not comprise such in-coupling grating and/or such intermediate pupil expansion structure.

As shown in FIG. 5, the display device 3000 further comprises an optical engine 3250 configured to direct light 3201 into the waveguide 3210 for propagation in the waveguide 3210 by total internal reflection. In other embodiments, a display device may or may not comprise such optical engine.

In the following, a number of examples are discussed.

In a first example, a first example display structure, a first reference display structure, and a second reference display structure were designed and optimized for single-color illumination at a λᵥᵢₛ of approximately 520 nm in a display device providing a field of view (FOV) of 15°. After optimization of these three display structures, their out-coupling efficiency characteristics were computed and compared.

The first example display structure comprised a waveguide, an in-coupling grating, and a diffractive three-level stepped out-coupling grating. The reference display structures were nearly identical to the example display structure. However, the first and second reference display structures were provided with a binary and a slanted out-coupling grating, respectively, instead of a stepped out-coupling grating. Each of these out-coupling gratings was configured for one-dimensional exit pupil expansion by pupil replication along a primary lateral direction and received light directly from an in-coupling grating in the absence of intermediate pupil expansion structures.

According to the results, the eye-to-world out-coupling efficiency ratio (r_{oc}^{e2w}) of the first reference display structure was approximately 1.6 throughout the FOV for TE-polarized input light and from 1.6 to 1.7 throughout the FOV for TM-polarized input light. For the second reference display structure, r_{oc}^{e2w} ranged from 17 to 23 in case of TE polarization and from 3 to 30 in case of TM polarization.

In case of the first example display structure, r_{oc}^{e2w} ranged from 30 to 110 in case of TE polarization and from 25 to 110 in case of TM polarization. As such, the first example display structure exhibited a r_{oc}^{e2w} approximately two orders of magnitude and one order of magnitude higher than those of the first and second reference display structures, respectively.

Additionally, the results indicated that the eye-side outcoupling efficiency (η_{oc}^{e}) of the first reference display structure ranged from 3.2% to 4.5% throughout the FOV for TE-polarized input light and from 1.6% to 2.3% throughout the FOV for TM-polarized input light, while η_{oc}^{e} of the second reference display structure ranged from 4.9% to 6.4% in case of TE-polarization and from 0.4% to 0.9% in case of TM polarization.

In case of the first example display structure, η_{oc}^{e} ranged from 4.4% to 4.6% in case of TE-polarization and from 3.5% to 6.8% in case of TM polarization. As such, the first example display structure exhibited an η_{oc}^{e} noticeably higher than those of the first and second reference display structures in case of TM polarization.

In a second example, a second example display structure was designed and optimized for single-color illumination at a λᵥᵢₛ of approximately 520 nm in a display device providing a FOV of 15°. After optimization of the second example display structure, the out-coupling efficiency characteristics thereof were computed and compared with those of the first and second reference display structures of the first example.

The second example display structure comprised a waveguide and an in-coupling grating identical to those of the first example display structure. However, the second example display structure comprised a diffractive out-coupling grating provided with ridges, wherein intermediate ridge portions comprising sloping intermediate outer surfaces extended from first ridge portions comprising lateral first outer surfaces to second ridge portions comprising lateral second outer surfaces, the intermediate outer surfaces connecting the first outer surfaces with the second outer surfaces. In other words, the ridges of the out-coupling grating of the second example display structure had shapes similar to those of the out-coupling grating 2200 of the embodiment of FIG. 2.

According to the results, the r_{oc}^{e2w} of the second example display structure ranged from 30 to 100 in case of TE polarization and from 30 to 65 in case of TM polarization. As such, the second example display structure exhibited a r_{oc}^{e2w} approximately two orders of magnitude and one order of magnitude higher than those of the first and second reference display structures, respectively.

Additionally, the results indicated that η_{oc}^{e} of the second example display structure ranged from 3.8% to 4% in case of TE polarization and from 4.2% to 8.3% in case of TM polarization. As such, the second example display structure exhibited an η_{oc}^{e} noticeably higher than those of the first and second reference display structures in case of TM polarization.

In the first and second examples discussed above, the first and second example display structures as well as the first and second reference display structures were designed and optimized for use with both TE-polarized and TM-polarized input light. Naturally, in case of display structures optimized for use with only one of TE-polarized and TM-polarized input light, higher values of r_{oc}^{e2w} and η_{oc}^{e} may be obtainable.

It is obvious to a person skilled in the art that with the advancement of technology, the basic idea of the invention may be implemented in various ways. The invention and its embodiments are thus not limited to the examples described above, instead they may vary within the scope of the claims.

It will be understood that any benefits and advantages described above may relate to one embodiment or may relate to several embodiments. The embodiments are not limited to those that solve any or all of the stated problems or those that have any or all of the stated benefits and advantages.

The term “comprising” is used in this specification to mean including the feature(s) or act(s) followed thereafter, without excluding the presence of one or more additional features or acts. It will further be understood that reference to ‘an’ item refers to one or more of those items.

REFERENCE SIGNS AND SYMBOLS

| | | |
|---|---|---|
| h₁ | | first height |
| h₂ | | second height |
| rₕ | =h₂/h₁ | height ratio |
| d | | period |
| dᵢᵣ | | inter-ridge distance |
| r_{d} | =dᵢᵣ/d | distance ratio |
| w₁ | | first width |
| w₂ | | second width |
| w₃ | | third width |
| r_{w} | =w₂/w₁ | width ratio |
| n₁ | | first refractive index |
| n₂ | | second refractive index |
| λᵥᵢₛ | | visible wavelength |
| Δn | =n₂ − n₁ | refractive index difference |
| r_{oc}^{e2w} | | outcoupling efficiency ratio |
| η_{oc}^{e} | | eye-side outcoupling efficiency |

1000 display structure
1100 waveguide
1101 light
1102 thickness direction
1110 first face
1120 second face
1200 out-coupling grating
1201 primary lateral direction
1202 secondary lateral direction
1210 primary ridge
1211 first end
1212 second end
1213 first ridge portion
1214 first outer surface
1215 second ridge portion
1216 second outer surface
1217 step structure
1220 secondary ridge
1300 coating
2000 display structure
2200 out-coupling grating
2210 primary ridge
2211 first end
2212 second end
2213 first ridge portion
2214 first outer surface
2215 second ridge portion
2216 second outer surface
2218 intermediate ridge portion
2219 intermediate outer surface
2220 secondary ridge
3000 display device
3100 frame
3200 display structure
3201 light
3210 waveguide
3220 in-coupling grating
3230 intermediate pupil expansion structure
3240 out-coupling grating
3250 optical engine

1. A display structure, comprising:
a waveguide comprising a first face and a second face for confining light in the waveguide by total internal reflection, the second face arranged towards a thickness direction from the first face; and
a diffractive out-coupling grating arranged on the first face, the out-coupling grating configured to couple light out of the waveguide via the second face;
wherein:
the out-coupling grating comprises a primary ridge and a secondary ridge parallel to the primary ridge, the secondary ridge arranged towards a primary lateral direction from the primary ridge;
the primary ridge comprises a first end facing a secondary lateral direction opposite to the primary lateral direction, a first ridge portion extending towards the primary lateral direction from the first end, a second end facing the primary lateral direction, and a second ridge portion extending towards the secondary lateral direction from the second end; and
the first ridge portion has a first height, h₁, measured along the thickness direction, the second ridge portion has a second height, h₂, measured along the thickness direction, less than the first height, h₁, and a height ratio, rₕ, between the second height, h₂, and the first height, h₁, is greater than or equal to 0.45.

2. A display structure according to claim 1, wherein the height ratio, rₕ, between the second height, h₂, and the first height, h₁, is greater than or equal to 0.5, or to 0.55, or to 0.6 and/or less than or equal to 0.9, or to 0.85, or to 0.8, or to 0.75.

3. A display structure according to claim 1, wherein the display structure comprises a coating on the first face, and the out-coupling grating is formed in the coating.

4. A display structure according to claim 3, wherein the waveguide comprises a first material having a first refractive index, n₁, at a visible wavelength, λᵥᵢₛ, and the coating comprises a second material having a second refractive index, n₂, higher than the first refractive index, n₁, at the visible wavelength, λᵥᵢₛ.

5. A display structure according to claim 4, wherein a refractive index difference, Δn, between the second refractive index, n₂, and the first refractive index, n₁, at the visible wavelength, λᵥᵢₛ, is greater than or equal to 0.3, or to 0.4, or to 0.5, or to 0.6, or to 0.7.

6. A display structure according to claim 4, wherein the visible wavelength, λᵥᵢₛ, is selected from the group consisting of 50 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, and 650 nm.

7. A display structure according to claim 1, wherein the out-coupling grating has a period, d, and an inter-ridge distance, dᵢᵣ, measured along the primary lateral direction between the primary ridge and the secondary ridge, and a distance ratio, r_{d}, between the inter-ridge distance, dᵢᵣ, and the period, d, is less than or equal to 0.25, or to 0.2, or to 0.15, or to 0.1.

8. A display structure according to claim 1, wherein the first ridge portion is adjacent to the second ridge portion, and the primary ridge comprises a step structure arranged between the first ridge portion and the second ridge portion.

9. A display structure according to claim 8, wherein the first ridge portion has a first width, w₁, measured along the primary lateral direction, and the second ridge portion has a second width, w₂, measured along the primary lateral direction, greater than the first width, w₁.

10. A display structure according to claim 9, wherein a width ratio, r_{w}, between the second width, w₂, and the first width, w₁, is greater than or equal to 1.1, or to 1.2, or to 1.3, or to 1.4 and/or less than or equal to 3, or to 2.8, or to 2.6, or to 2.5, or to 2.4.

11. A display structure according to claim 1, wherein the first ridge portion comprises a lateral first outer surface extending from the first end, the second ridge portion comprises a lateral second outer surface extending from the second end, and the primary ridge comprises an intermediate ridge portion extending from the first ridge portion to the second ridge portion and comprising a sloping intermediate outer surface connecting the first outer surface and the second outer surface.

12. A display structure according to claim 1, wherein the out-coupling grating is configured to perform exit pupil expansion by pupil replication along at least the primary lateral direction.

13. A display structure according to claim 1, wherein the out-coupling grating is configured to minimize coupling of light out of the waveguide via the first face.

14. A display device, comprising a display structure according to claim 1.

15. A display device according to claim 14 implemented as a see-through display device.

16. A display device according to claim 14 implemented as a head-mounted display device.
